(19) United States
(12) Patent Application Publication
(10) Pub. No.: US 2020/0018276 A1
(43) Pub. Date: Jan. 16, 2020

(54) MULTI-DIMPLE ORIFICE DISC FOR A FLUID INJECTOR, AND METHODS FOR CONSTRUCTING AND UTILIZING SAME

(71) Applicant: Continental Automotive Systems, Inc., Auburn HIlls, MI (US)

(72) Inventors: Cesar Elpidio Castejon Reyes, Quinton, VA (US); Hamid Sayar, Newport News, VA (US)

(73) Assignee: Continental Automotive Systems, Inc., Auburn Hills, MI (US)

(21) Appl. No.: 16/036,591

(22) Filed: Jul. 16, 2018

(51) Int. Cl. F02M 61/18

(52) U.S. Cl. CPC F02M 61/1886; F02M 61/1806; F02M 61/1853

(57) ABSTRACT

A fluid injector for injecting fluid is disclosed, including a body, a fluid passageway defined through the body and extending from an inlet to an outlet of the fluid injector; a valve seat disposed internally of the body and forming part of the passageway; and a valve element that is selectively reciprocated relative to the valve seat to close and open the passageway to the flow of fluid by seating and unseating the valve element on and from the valve seat, respectively. The fluid injector further includes an orifice disc disposed in the passageway downstream of the valve seat in a direction of the flow of fluid through the fluid injector. The orifice disc includes a plurality of dimples and a plurality of orifices defined through the orifice disc, with each dimple including at least one orifice defined therethrough.

### FIELD OF INVENTION

The present invention generally relates to an orifice disc for a fluid injector, and particularly to an orifice disc having multiple dimples on which orifices are defined.

### BACKGROUND

Fluid injectors are typically used to introduce fluid into a desired location, such as fluid into the combustion chamber of a gas combustion engine or a reductant into the exhaust stream of a vehicle having such an engine. To operate most effectively, injection systems require good atomization of the fluid being injected. Spray generation, or atomization, is created by the fluid stream breaking into droplets, while being directed in a specific direction. Breakup of the fluid stream is enhanced by keeping the fluid turbulent as it exits the fluid injector.

Some existing fluid injectors include a disc or plate which may have several exit orifices through which the fluid passes as the fluid exits the fluid injector. Some of these discs include a protrusion or dimple along which the orifices are located. The size and shape of the orifices as well as their locations along the dimple, together with the size and shape of the dimple, at least partly define the spray pattern of fluid exiting the fluid injector. These existing fluid injectors, however, are limited in failing to allow for the production of fluid spray patterns for any of a large number of fluid injection applications.

### SUMMARY

Example embodiments overcome shortcomings found in existing fluid injectors and provide an improved fluid injector. According to an example embodiment, a fluid injector for injecting fluid, including a body; a fluid passageway defined through the body and extending from an inlet to an outlet of the fluid injector; a valve seat disposed internally of the body and forming part of the passageway; and a valve element that is selectively reciprocated relative to the valve seat to close and open the passageway to flow of fluid by seating and unseating the valve element on and from the valve seat, respectively. The fluid injector further includes an orifice disc disposed in the passageway downstream of the valve seat in a direction of the flow of fluid through the fluid injector, the orifice disc including a plurality of dimples and a plurality of orifices defined through the orifice disc, each dimple including at least one orifice defined therethrough. In an example embodiment, each dimple includes a single orifice defined therethrough.

Each dimple may be dome shaped. In an example embodiment, the plurality of dimples are the same size. In another embodiment, the plurality of dimples have at least one of the same diameter and the same depth. A dimple of the plurality of dimples may have at least one of a diameter and a depth that is different from a diameter and depth, respectively, of at least one other dimple of the plurality of dimples.

The plurality of dimples may include a first dimple having a first orifice and a second dimple having a second orifice, and the first orifice and the second orifice face each other such that fluid exiting the fluid injector through the first orifice impacts fluid exiting the fluid injector through the second orifice.

In an example embodiment, the plurality of dimples are situated relative to each other on the orifice disc, and each orifice is disposed along the corresponding dimple such that fluid exiting the fluid injector by passing through the orifice disc forms a substantially elliptical spray pattern.

In an example embodiment, each orifice may be disposed at a location on the respective dimple that is different from a location of each of the other orifices along the respective dimples thereof, relative to a radial center of the orifice disc. Further, each dimple may be dome shaped having a diameter between 300 microns and 700 microns, and the orifice corresponding to the dimple has a diameter between 0.25 and 0.40 times the diameter of the dimple.

A method of forming an orifice disc for a fluid injector includes: performing a plurality of first punch operations on the orifice disc, each first punch operation forming an orifice defined through the orifice disc; and performing a plurality of second punch operations, each second punch operation forming a dimple on the orifice disc such that the orifice disc includes a plurality of dimples, each dimple including an orifice defined therethrough.

In an example embodiment, the plurality of first punch operations are performed after performing the plurality of second punch operations. In another example embodiment, the plurality of first punch operations are performed before performing the plurality of second punch operations.

Each first punch operation may include punching a punch member through the orifice disc in an axial direction thereof.

In an example embodiment, each dimple is dome shaped having a diameter between 300 microns and 700 microns, and the orifice corresponding to the dimple has a diameter between 0.25 and 0.40 times the diameter of the dimple.

Each orifice may be disposed at a location on the respective dimple that is different from a location of each of the other orifices along the respective dimples thereof, relative to a radial center of the orifice disc.

In example embodiment, the plurality of dimples are the same size. In another example embodiment, the plurality of dimples may have at least one of the same diameter and the same depth.

In an aspect, each dimple includes a single orifice defined therethrough.

In an example embodiment, the plurality of first punch operations are performed with the same punch member.

### BRIEF DESCRIPTION OF THE DRAWINGS

Aspects of the invention will be explained in detail below with reference to an exemplary embodiment in conjunction with the drawings, in which:

FIG. 1 is a cross-sectional side view of a fluid injector according to an example embodiment;

FIG. 1A is an enlarged view of an outlet portion of the fluid injector of FIG. 1;

FIGS. 2 and 3 are perspective and top plan views, respectively, of an orifice disc in the fluid injector of FIG. 1 according to an example embodiment;

FIGS. 4, 5 and 6 are perspective, top, and cross sectional views, respectively, of an orifice disc for the fluid injector of FIGS. 1 and 1A according to another example embodiment; and

FIG. 7 is a flowchart depicting a method of making the orifice discs of FIGS. 2-5 according to an example embodiment.

### DETAILED DESCRIPTION

The following description of the preferred embodiment(s) is merely exemplary in nature and is in no way intended to limit the invention, its application, or uses.

Example embodiments are generally directed to an orifice disc disposed at the outlet end of a fluid injector which affects the spray pattern of the fluid discharged from the injector.

It is understood that references to “upstream” and “downstream” herein are relative to the flow of a fluid through the fluid injector.

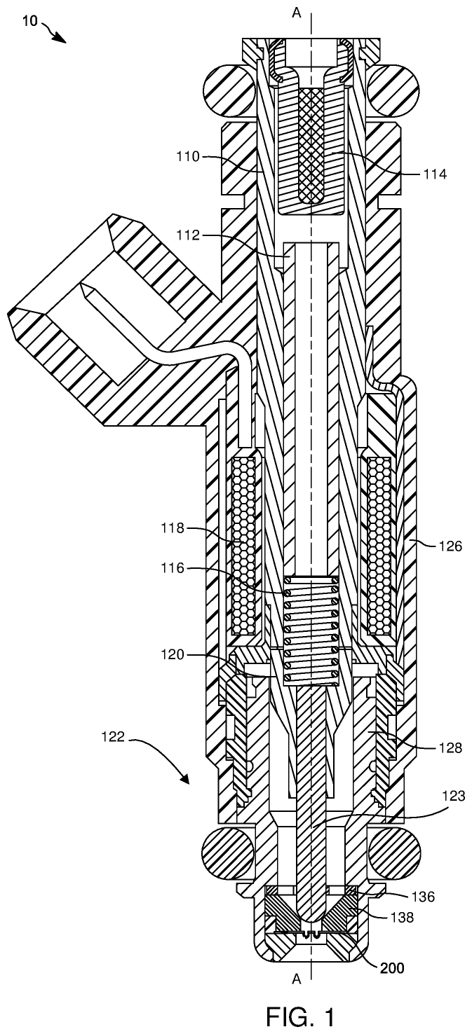

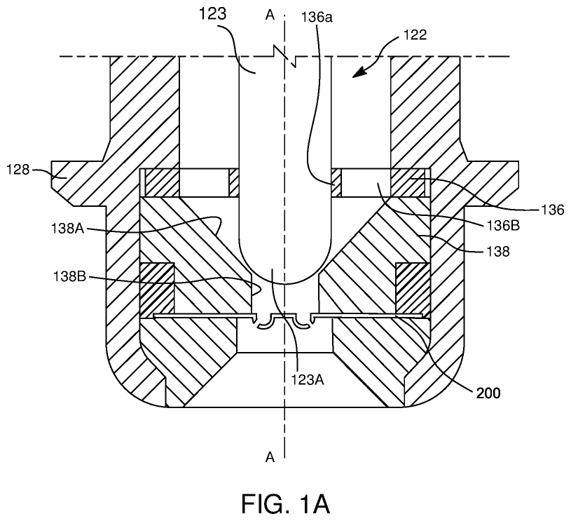

FIGS. 1 and 1A illustrate a solenoid-actuated fluid injector 10 according to an example embodiment. In particular, fluid injector 10 includes: a fluid inlet tube or body 110 which receives a fluid at an inlet of the injector; a calibration adjustment tube 112; a filter assembly 114 for filtering the fluid entering the fluid injector 10; a fluid injector overmold 126 which largely houses the components of the fluid injector; and a coil 118 forming part of the solenoid actuator along with a movable armature 120 and a coil spring 116. A fluid passageway is defined between the inlet of fluid injector 10 to an outlet thereof. A valve assembly 122 includes a valve body 128 in which a movable closure member 123, which is coupled to armature 120, and a valve seat 138 are disposed. Valve body 128 and fluid inlet tube 110 define an injector body having the fluid passageway which extends from the injector inlet to the injector outlet. The valve assembly 122, under control of the solenoid actuator, is selectively switched between an open state in which fluid in fluid injector 10 exits the injector, and a closed state in which fluid is preventing from exiting the injector. The construction of fluid injector 10 can be of a type similar to those disclosed in commonly assigned U.S. Pat. Nos. 4,854,024; 5,174,505; and 6,520,421, which are incorporated by reference herein in their entireties.

FIG. 1A shows the fluid outlet end of the valve body 128 of fluid injector 10 according to an example embodiment. The outlet end of fluid injector 10 includes an orifice disc 200, a guide member 136 and the valve seat 138, the latter two of which are disposed axially interiorly of orifice disc 200. The guide member 136, valve seat 138 and orifice disc 200 may be retained in fluid injector 10 by a suitable technique such as, for example, by welding the orifice disc 200 to the valve seat 138 and welding the valve seat 138 to the valve body 128.

Valve seat 138 may include a frusto-conical shaped seating surface 138A that leads from guide member 136 to a central passage 1388 of the valve seat 138 that, in turn, leads to orifice disc 200. Guide member 136 includes a central guide opening 136A for guiding the axial reciprocation of a sealing end 123A of the closure member 123, and several through-openings 1368 distributed around opening 136A to provide for fluid to flow into the sac volume. The fluid sac volume is the encased volume downstream of the sealing seat perimeter of the closure member 123, which in this case is the volume between the interface of sealing end 123A and seating surface 138A, and the metering orifices of orifice disc 200. FIG. 1A shows the hemispherical sealing end 123A of closure member 123 displaced from sealing surface 138A, thus allowing fluid flow from fluid injector 10.

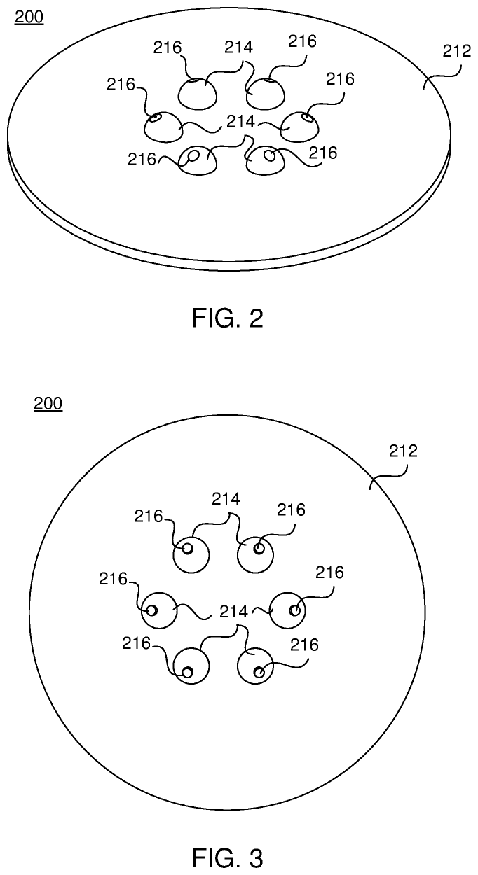

FIGS. 2 and 3 illustrate orifice disc 200 according to an example embodiment. Orifice disc 200 is constructed from a metal or metal composition and have punched features defined thereon. As can be seen, orifice disc 200 includes a flat portion 212 and a plurality of protrusions or dimples 214. Dimples 214 are generally radially centrally located along orifice disc 200 and extend from flat portion 212 in the direction of fluid flow through injector 10. In an example embodiment, dimples 214 of the orifice disc 200 of FIGS. 2 and 3 are evenly distributed about a radial center of orifice disc 200. Each dimple 214 includes a concave surface defined along the upstream surface of orifice disc 200 and a convex surface defined along and protruding from the downstream surface of orifice disc 200. Though FIGS. 2 and 3 depict orifice disc 200 as including six dimples 214, it is understood that orifice disc 200 may include more or less than six dimples 214 depending upon the particular fluid spray pattern desired.

With continued reference to FIGS. 2 and 3, orifice disc 200 further includes a plurality of orifices 16 defined through the disc. In the illustrated embodiment, each dimple 214 includes a single orifice 216. It is understood, however, that in other embodiments, one or more dimples 214 may include more than one orifice 216. Orifices 216 provide for fluid in fluid injector 10 to exit the injector via the fluid outlet thereof.

Each dimple 214 is sized smaller than dimples in existing orifice plates. In an example embodiment, each dimple 214 may have a diameter between 300 microns and 700 microns, and particularly between 400 microns and 600 microns, such as 500 microns. In an example embodiment, each orifice 216 is sized so that the diameter thereof is between 25% and 40% of the diameter of the corresponding dimple 214, such as 33%.

In an example embodiment, all of the dimples 214 are semi-spherical, having the same diameter and the same depth. It is understood, however, that two or more dimples 214 may have different diameters, different depths or both different diameters and different depths. In another embodiment, two or more dimples 214 may have different shapes, different dimensions, or both different shapes and different dimensions.

In an example embodiment, two or more orifices 216 may have different shapes, different dimensions, or both different shapes and different dimensions. It is understood, however, that all of the orifices 216 may have the same shape and dimensions.

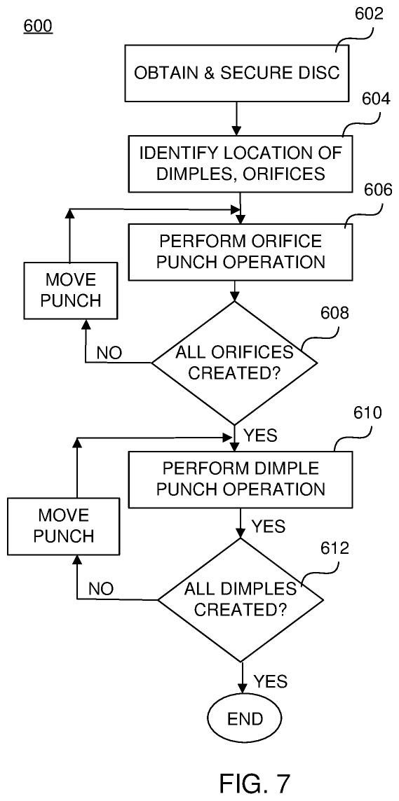

A method 600 of forming orifice disc 200 will be described with reference to FIG. 7. Though method 600 includes a number of steps or acts which are presented in a particular order, it is understood that the order of steps may vary from the depicted order.

Method 600 begins at 602 with obtaining and suitably securing a blank disc to be worked. The location of the dimples 214 and orifices 216 to be formed on the blank disc are identified at 604. Next, a set or series of orifice punch operations are performed at 606. Each orifice punch operation 606 forms a single orifice 216. The punch operations may be performed serially in time, as depicted in FIG. 7, or simultaneously. If serial orifice punch operations 606 are performed, between punch operations the punch member may be moved to the next desired orifice location on the disc. If desired, method 600 may also optionally include, between punch operations, switching between different punch members so as to form orifices having different shapes and sizes. In an example embodiment, the punch member used in each orifice punch operation 606 punches through the disc in a direction that is orthogonal to the flat surfaces of the disc. Stated another way, the punch member used in each punch operation 606 punches through the disc in an axial direction of the disc. It is understood that in other embodiments, the punch member used in one or more orifice punch operations 606 may punch through the disc and form an orifice in a direction that is other than orthogonal to the flat surfaces of the disc and/or the axial direction thereof.

Method 600 further includes performing a set or series of dimple punch operations at 608. Each dimple punch operation 608 forms a single dimple 214. The dimple punch operations 608 may be performed serially in time, as depicted in FIG. 7, or simultaneously. If serial punch operations are performed, between punch operations the dimple punch member may be moved to the location of the next dimple 214 to be formed. If desired, method 600 may also optionally include, between dimple punch operations 608, switching between different punch members so as to form dimples 214 having different shapes, sizes or both shapes and sizes. In an example embodiment, the same punch member is used to form all of the dimples 214 such that the dimples 214 have the same shape and size, such as dimples 214 being semi-spherical with the same diameter and depth.

Each dimple punch operation 608 forms a dimple 214 relative to an orifice location so that upon completion of the orifice punch operations 606 and dimple punch operations 608, each orifice 216 is defined along a distinct dimple 214. In an example embodiment depicted in FIG. 7, the orifice punching operations 606 are performed prior to the dimple punching operations 608 being performed. In another example embodiment, the orifice punching operations 606 are performed after the dimple punching operations 608 are performed. A benefit of performing the orifice punching operations 606 prior to performing the dimple punching operations 608 is that orifice forming is simplified and, as explained above, more easily allow for orifice punching in an axial direction of the disc being worked. In either embodiment in which dimples 214 are semi-spherical in shape, the location of each orifice 216 along its corresponding dimple 214 may be located between 0 degrees and 90 degrees along dimple 214.

The locations of each orifice 216 relative to its associated dimple 214 at least partly determines the shape of the orifice along the dimple and thus the direction of fluid exiting fluid injector 10 through orifice 216. The shape of each orifice 216 is also dependent upon whether the corresponding dimple 14 is formed prior to or following orifice 216 being formed.

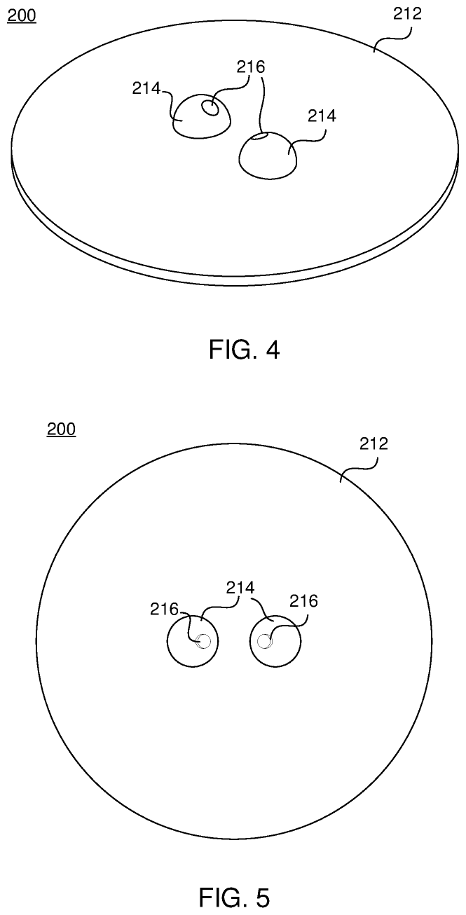

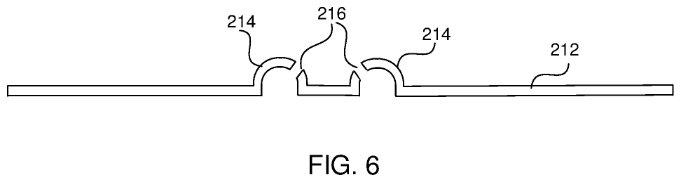

Based upon the methods for forming the orifice discs 200 disclosed herein, it is clear that the location selection of each orifice 216 and its corresponding dimple 214 results in enhanced customization of, and enhanced flexibility in, the positioning and orientation of orifices 216. This results in greater customization of and control over the spray pattern of fluid exiting fluid injector 10. For example, FIGS. 4-6 illustrate an orifice disc 200 according to another example embodiment. In this embodiment, disc 200 includes two dimples 214, with each dimple 214 including an orifice 216. As can be seen, the locations of dimples 214 are spaced on either side of the radial center of disc 200. Further, the two orifices 216 largely face each other. The fluid exiting each orifice 216 thus impacts or otherwise impinges each other, thereby creating a complex spray pattern of fluid exiting fluid injector 10 via orifice disc 200.

Still further, the use of a plurality of smaller dimples 214, relative to existing orifice plates using a single, relatively large dimple, results in the fluid sac volume, corresponding to the encased volume downstream of the sealing seat perimeter along seating surface 138A of valve seat 138, which in this case is the volume between the interface of sealing end 123A of the closure member 123 and seating surface 138A, and orifices 216 of orifice disc 200, being advantageously reduced.

Fluid injector 10, including orifice disc 200, may be a fuel injector for injecting fuel into the combustion chamber of a gas combustion engine. Alternatively, fluid injector 10 may be an injector for a reductant delivery unit of a selective catalytic reduction system in which a reductant is injected into the exhaust stream of a vehicle's exhaust line for reducing the vehicle's nitrogen oxide emissions. Further, fluid injector 10 may be used in other applications in which a fluid injector is utilized.

It is understood that the particular dimensions of the components illustrated in the drawings, and particularly the dimensions of dimples 214 and orifices 216 appearing on orifice disc 200, are not necessarily to scale so as to better show the component features and characteristics.

The example embodiments have been described herein in an illustrative manner, and it is to be understood that the terminology which has been used is intended to be in the nature of words of description rather than of limitation. Obviously, many modifications and variations of the invention are possible in light of the above teachings. The description above is merely exemplary in nature and, thus, variations may be made thereto without departing from the spirit and scope of the invention as defined in the appended claims.

What is claimed is:

1. A fluid injector for injecting fluid, comprising:
a body;
a fluid passageway defined in the body and extending from an inlet to an outlet of the fluid injector;
a valve seat disposed internally of the body and forming part of the passageway;
a valve element that is selectively reciprocated relative to the valve seat to close and open the passageway to fluid flow by seating and unseating the valve element on and from the valve seat, respectively; and
an orifice disc disposed in the passageway downstream of the valve seat in a direction of the fluid flow through the fluid injector, the orifice disc including a plurality of dimples and a plurality of orifices defined through the orifice disc, each dimple including at least one orifice located thereon.

2. The fluid injector of claim 1, wherein each dimple includes a single orifice located thereon.

3. The fluid injector of claim 1, wherein each dimple is dome shaped.

4. The fluid injector of claim 3, wherein the plurality of dimples are the same size.

5. The fluid injector of claim 3, wherein the plurality of dimples have at least one of the same diameter and the same depth.

6. The fluid injector of claim 3, wherein a dimple of the plurality of dimples has at least one of a diameter and a depth that is different from a diameter and depth, respectively, of at least one other dimple of the plurality of dimples.

7. The fluid injector of claim 1, wherein the plurality of dimples includes a first dimple having a first orifice and a second dimple having a second orifice, and the first orifice and the second orifice face each other such that fluid exiting the fluid injector through the first orifice impacts fluid exiting the fluid injector through the second orifice.

8. The fluid injector of claim 1, wherein at least one dimple has at least one of a shape and a dimension that is different from a shape and a dimension, respectively, of another dimple of the plurality of dimples.

9. The fluid injector of claim 1, wherein each orifice is disposed at a location on the respective dimple that is different from a location of each of the other orifices along the respective dimples thereof, relative to a radial center of the orifice disc.

10. The fluid injector of claim 1, wherein each dimple is dome shaped having a diameter between 300 microns and 700 microns, and the orifice corresponding to the dimple has a diameter between 0.25 and 0.40 times the diameter of the dimple.

11. A method of forming an orifice disc for a fluid injector, comprising:
performing a plurality of first punch operations on the orifice disc, each first punch operation forming an orifice defined through the orifice disc; and
performing a plurality of second punch operations, each second punch operation forming a dimple on the orifice disc such that the orifice disc includes a plurality of dimples, each dimple including an orifice defined therethrough.

12. The method of claim 11, wherein the plurality of first punch operations are performed after performing the plurality of second punch operations.

13. The method of claim 11, wherein the plurality of first punch operations are performed before performing the plurality of second punch operations.

14. The method of claim 13, wherein each first punch operation comprises punching a punch member through the orifice disc in an axial direction thereof.

15. The method of claim 13, wherein the each dimple is dome shaped having a diameter between 200 microns and 700 microns, and the orifice corresponding to the dimple has a diameter between 0.25 and 0.40 times the diameter of the dimple.

16. The method of claim 11, wherein at least one dimple has at least one of a shape and a dimension that is different from a shape and a dimension, respectively, of another dimple of the plurality of dimples.

17. The method of claim 11, wherein the plurality of dimples are the same shape and the same size.

18. The method of claim 11, wherein the plurality of dimples have at least one of the same diameter and the same depth.

19. The method of claim 11, wherein each dimple includes a single orifice defined therethrough.

20. The method of claim 11, wherein the plurality of first punch operations are performed with the same punch member.
